(19) United States
(12) Patent Application Publication
(10) Pub. No.: US 2026/0327506 A1
(43) Pub. Date: Oct. 22, 2026

(54) GASIFICATION PROCESSES AND SYSTEMS FOR THE PRODUCTION OF RENEWABLE HYDROGEN

(71) Applicant: SunGas Renewables, Inc., Houston, TX (US)

(72) Inventors: Terry HUGHES, Jersey Village, TX (US); Andrew KRAMER, St. Charles, IL (US)

(21) Appl. No.: 19/110,530

(22) PCT Filed: Sep. 12, 2023
(86) PCT No.: PCT/US2023/073984

§ 371 Date: Mar. 11, 2025

Related U.S. Application Data
(60) Provisional application No. 63/406,005, filed on Sep. 13, 2022.

(51) Int. Cl. C10J 3/46; C10K 1/00; C10K 3/04

(52) U.S. Cl. CPC C10J 3/466; C10K 1/004; C10K 3/04; C10J 2300/0916; C10J 2300/0959; C10J 2300/1618; C10J 2300/1892

(57) ABSTRACT

Gasification processes for renewable hydrogen production utilize a sour water-gas shift (WGS) operation that is implemented at a stage at which the gas composition and conditions favor H₂ productivity, thereby gaining efficiency advantages. The sour WGS operation may be conducted following increasing the concentration of sulfur in the gasifier effluent, such as by combining the gasifier effluent with a gas stream comprising sulfur compounds. This gas stream may be readily available as an acid gas product comprising H₂S, obtained from a downstream acid gas removal operation that is recycled to the sour WGS operation or upstream of this operation.

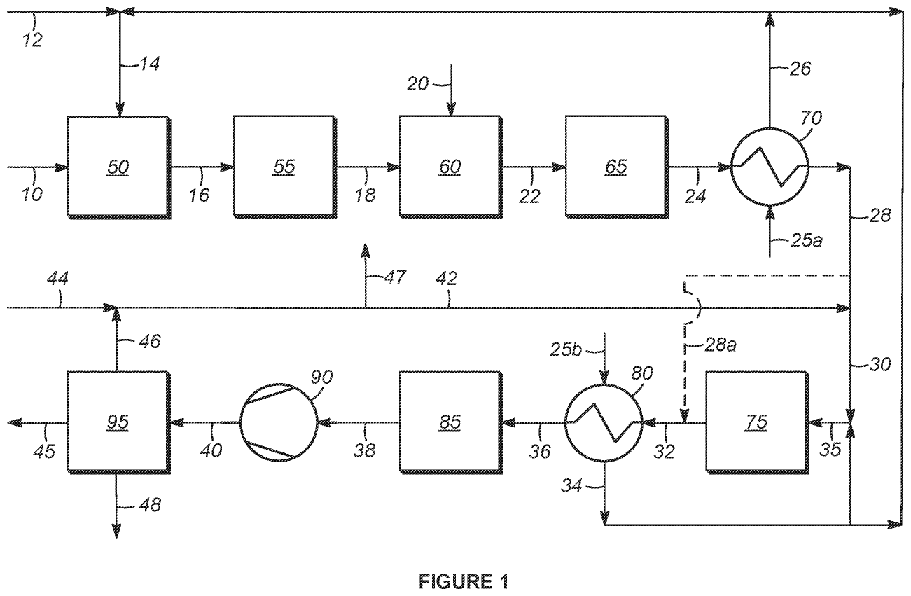

### FIELD OF THE INVENTION

Aspects of the invention relate to gasification processes in which the gasifier effluent is subjected to a series of operations, including a sour water-gas shift (WGS) operation, for the efficient production and recovery of renewable hydrogen. Further aspects relate to the use of an acid gas product comprising sulfur compounds (e.g., H₂S) for recycle to the sour WGS operation.

### DESCRIPTION OF RELATED ART

The gasification of coal has been performed industrially for over a century in the production of synthesis gas (syngas) that can be further processed into transportation fuels. More recent efforts toward developing energy independence with reduced greenhouse gas emissions have led to a strong interest in using biomass as a gasification feed, and thereby an alternative potential source of synthesis gas, as well as its downstream conversion products. Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which is often referred to as synthesis gas in view of its H₂ and CO content, is treated to remove a number of undesired components that can include particulates, alkali metals, and sulfur compounds, in addition to byproducts of gasification that are generally referred to as tars and oils. Such treatment steps are necessary to render the gasifier effluent/synthesis gas product suitable for downstream conversion of the significant concentrations of H₂ and CO/CO₂ to value-added products. These include renewable natural gas (RNG) or biomethane, produced via catalytic methanation that increases the methane content. Alternatively, Fischer-Tropsch synthesis can be employed to provide higher molecular weight hydrocarbons and/or alcohols of varying carbon numbers.

The hydrogen content of the synthesis gas is an important parameter for carrying out subsequent reactions, utilizing its H₂ and CO building blocks. In some cases, obtaining purified, renewable hydrogen from gasification is the processing objective, for a wide array of possible end uses such as fuel cell electricity generation or refinery hydroprocessing. Depending on the specific need or downstream conversion, a significantly higher concentration of hydrogen may be required, compared to that available in the gasifier effluent, and for some applications a product of essentially all hydrogen is optimal. In this regard, the exothermic water-gas shift (WGS) reaction is widely implemented for increasing the hydrogen content of synthesis gas according to:

CO+H₂O⇄H₂+CO₂,

with thermodynamics dictating an equilibrium shift toward hydrogen production at lower temperatures, which are generally unfavorable from the standpoint of reaction kinetics. In addition, whereas higher steam concentrations can likewise drive the reaction in the intended direction, operations conducted to prepare the gasifier effluent, or synthesis gas, for catalytic WGS can dehydrate this stream.

Overall, process efficiency is sacrificed when certain conditions (e.g., temperature, humidity) existing upstream of the WGS reaction must be “undone” to attain needed synthesis gas purity characteristics and then “restored” to achieve acceptable conversion levels and associated hydrogen concentrations. This is practiced, for example, when gasifier-produced synthesis gas is treated to remove tars and oils and then scrubbed to remove water-and water-soluble contaminants. The former tar removal operation, which is necessary to clean the synthesis gas for further processing, is often performed according to a thermal approach that allows for the recovery of significant high-grade heat. The resulting elevated temperatures, however, shift the equilibrium in the synthesis gas to an undesirably low hydrogen concentration, i.e., by favoring the left side of the reaction above. The latter scrubbing operation causes significant reductions in heat and moisture content. Consequently, attaining a desired H₂:CO molar ratio and/or H₂ concentration, or, through the WGS reaction requires that the gas input to this conversion step must be reheated and replenished with steam. Directly upstream of this reaction, this gas is furthermore normally pressurized and contacted with adsorbent beds to remove residual quantities of sulfur compounds and other contaminants, as necessary to carry out a “sweet” (i.e., sulfur-free) catalytic WGS operation.

The present state of the art would benefit from efficient solutions to address conflicting requirements, including those described above, which are encountered in the processing of gasifier effluents. This need is particularly relevant with respect to the gasification of biomass in for production of renewable hydrogen, in view of challenges that pertain to the composition of the feed and implementation of the WGS reaction.

### SUMMARY OF THE INVENTION

Aspects of the invention are associated with the discovery of gasification processes for renewable hydrogen production, which utilize a sour water-gas shift (WGS) operation, i.e., one or more WGS reactions that are performed on a gas stream containing sulfur compounds (e.g., H₂S). Advantageously, this operation can be implemented within the overall process, at a stage in which the gas composition and conditions “naturally” favor H₂ productivity. The sour WGS operation may be conducted following increasing the concentration of sulfur in the gasifier effluent. This may be achieved by combining the gasifier effluent with a gas stream comprising sulfur compounds, such as an acid gas product comprising H₂S, obtained from downstream operations. For example, an acid gas removal operation may be used to separate the acid gas product, which may then be recycled to the sour WGS operation or upstream of this operation.

Importantly, the ability to concentrate sulfur through gas separation (e.g., using a physical or chemical solvent) can overcome the generally very limited sulfur content of biomass, which would otherwise prevent the use of a sour WGS operation, and more particularly a catalyst for this operation, having metals that are active when maintained in their sulfided state. The ability to use a sour WGS operation, in turn, overcomes conventional constraints encountered with respect to the placement of a “sweet” WGS operation within the overall process. Such placement has necessarily been downstream of required scrubbing and acid gas removal operations for purposes mainly related to protecting the WGS catalyst. Further aspects of the invention are therefore associated with the discovery of biomass gasification processes having multiple unit operations, in which a WGS operation is performed (fed with a gasifier-produced synthesis gas, or gasifier effluent) prior to (upstream of) a scrubbing operation and/or an acid gas removal operation.

Particular aspects of the invention therefore relate to gasification processes for effectively addressing the problem that biomass (unlike coal), as a desirable feedstock, has a sulfur content that is insufficient, according to conventional gasifier effluent processing steps, to support the use of catalysts for sour WGS. These catalysts are typically based on Co, Mo, Ni, and/or W that are catalytically active in their sulfided state. Despite this potential incompatibility, the attractiveness of a sour WGS operation, especially if the hydrogen concentration of the gasifier-produced synthesis gas is to be maximized, nonetheless arises from its potential to compensate for unacceptably low H₂:CO molar ratios obtained at conditions characteristic of thermal tar conversion reactions (e.g., reforming and/or partial oxidation). That is, hydrogen production at the high temperatures associated with tar removal, according to the equilibrium-limited WGS reaction, is thermodynamically disfavored.

In view of this, and further considering that sufficient water in the synthesis gas can drive the WGS reaction in the desired direction, advantages may be gained by direct water addition to the synthesis gas following tar removal, which serves additional purposes of temperature reduction to allow for gas filtering and the generation of the steam needed for the overall process. Further temperature reduction following steam generation also improves the thermodynamic environment in the sour WGS reactor(s) toward H₂ production. Whereas these reactor(s) of the sour WGS operation normally require a reaction environment having a requisite sulfur content (concentration) for maintaining catalyst metals in their active, sulfided state, this may be achieved, in certain embodiments, by recycling sulfur in an acid gas product. This product may be obtained, for example, by separation from the sour WGS product, such as by contacting it with a physical or chemical solvent used in a downstream acid gas removal operation. In some cases, this operation may provide (i) the acid gas product (e.g., an H₂S-enriched product) that forms at least a portion of sulfur-containing recycle gas that is combined with the gasifier effluent upstream of or within the sour WGS operation, in addition to (ii) a CO₂-enriched product. Accordingly, the acid gas removal operation may be performed using a physical or chemical solvent and in a manner that provides both products (i) and (ii) separately, with the former being recycled and the latter being sent for further processing.

Regardless of the particular manner in which an acid gas product or other sulfur-containing gas is obtained for enriching the sulfur content (concentration) of the gasifier effluent for use in the sour WGS operation, aspects of the invention relate to biomass gasification processes in which this operation is performed on the gasifier effluent in a state within the overall multi-operation process that provides suitable, most favorable, or even optimal, pressure, temperature, and moisture content for the WGS reaction to proceed forward for hydrogen production. Losses in process efficiency associated with the need for dedicated adjustments to these parameters, and particularly one or more “counteracting” adjustments (e.g., heating of the gasifier effluent following upstream cooling or steam addition to the gasifier effluent following upstream dehydration) are advantageously avoided. The addition of sulfur (e.g., as H₂S) to the sour WGS operation, and preferably through the conversion, recovery, and recycle of sulfur originally present in the biomass (e.g., with accumulation of H₂S to a desired concentration in a sulfur-containing recycle gas, as part of a recycle loop) advantageously allows for the use of the sour WGS catalyst for this operation. Particular embodiments of the invention are therefore directed to biomass gasification processes that utilize a series of unit operations, preferably with at least some being ordered specifically upstream or downstream relative to others, to achieve advantageous results as described herein. According to certain processes, an acid gas removal operation is used to separate a sulfur-containing (e.g., H₂S-containing) acid gas product from the sour WGS product that is obtained from a sour WGS operation downstream of the gasifier and upstream of the acid gas removal operation. Recycle of the separated acid gas product allows for the effective control of parameters such as the H₂:CO molar ratio of the sour WGS product and/or the H₂S concentration of the sulfur-containing recycle gas, more specifically by utilizing the level of recycle needed for a given sour WGS catalyst. According to specific embodiments, the use of such catalyst together with a physical or chemical solvent in the downstream acid gas removal operation allow for the effective recycle of biomass sulfur, which manifests predominantly as H₂S following gasification, as needed to maintain a desired sulfur concentration in the recycle loop for the sour WGS catalyst to perform effectively.

Some advantages of the invention can reside in the use of steam and heat present in the gasifier effluent, as well as the use of evaporative cooling via water injection into this effluent, to both raise its moisture content and provide cooling. These conditioning steps upstream of a sour WGS operation, coupled with the recycle of H₂S to this operation to maintain catalyst performance, allow for the effective and efficient production of hydrogen via biomass gasification, according to processes described herein.

Certain embodiments of the invention are directed to the production of hydrogen from gasifier-produced and biomass-derived synthesis gas that is subjected to sequential operations or treatment steps such as tar removal (e.g., carried out thermally, catalytically, or by adsorption), followed by dry quenching through direct contact with quench water. This provides a quenched gasifier effluent, or more specifically a partially quenched gasifier effluent, having a temperature above its dew point. For example, the synthesis gas obtained directly from the gasifier, or raw gasifier effluent, may be fed to a tar removal operation that is more particularly a partial oxidation (Pox) unit, with additional sources of oxygen (e.g., H₂O, CO₂) for carrying out the reforming of tars and oils. Following this tar removal operation, the tar-depleted gasifier effluent may be fed to the dry quenching operation, in which sufficient water is added such that, through evaporative cooling, the resulting quenched gasifier effluent is reduced in temperature to a desired extent (e.g., to about 480° C.) for further operations. These include filtration to remove solid particles (e.g., dust), as well as pre-shift heat recovery to generate steam and further cool the gas, thereby providing a cooled gasifier effluent having a temperature suitable for feeding to a sour WGS operation. Water introduced in the dry quenching operation, together with a recycled acid gas product that includes sulfur compounds (e.g., H₂S), serve to adjust the synthesis gas (or gasifier effluent) conditions and composition, thereby rendering it suitable for the sour WGS operation. This operation may be at least partly controlled by bypassing more or less of the synthesis gas around this operation, to achieve a targeted H₂:CO molar ratio. A post-shift heat recovery performed on the sour WGS product can recover at least some of the exothermic heat of the sour WGS operation and generate additional steam, prior to feeding of the sour WGS product to a scrubbing operation, and optionally a compressor, that renders the scrubbed and/or pressurized gas more suitable for further downstream processing. Steam generated from the pre-shift heat recovery and/or post-shift heat recovery may be utilized in the gasifier and/or sour WGS operation.

Following the post-shift heat recovery, the cooled sour WGS product may be further cooled by direct water contact in a subsequent scrubbing operation (e.g., wet scrubber), with the lower grade heat possibly being rejected to a system outside of the battery limits. The synthesis gas at this stage, which can be characterized as a scrubbed sour WGS product, may be compressed and fed to an acid gas removal operation, such as in the case of being processed through a gas sweetening unit that operates using a physical or chemical solvent. This can generate both a concentrated carbon dioxide gas stream (or CO₂-enriched product) in addition to a concentrated hydrogen sulfide gas stream (or H₂S-enriched product), with the latter of these two acid gas products being advantageously recycled to the sour WGS operation to as needed for its effective performance. Sulfur losses throughout the process, such as solution losses due to small quantities of solubilized H₂S, can be compensated for by the low but finite amount of sulfur contained in the biomass feedstock (e.g., wood).

Particular embodiments of the invention are directed to processes for gasification of a carbonaceous feed to produce a renewable hydrogen product, according to which the sulfur concentration of the gasifier effluent is increased for its use in a sour WGS operation. Representative processes comprise: (a) in a gasifier, contacting the carbonaceous feed with an oxygen-containing gasifier feed, under gasification conditions, to provide a gasifier effluent comprising synthesis gas (which includes both H₂ and CO); (b) increasing the sulfur concentration of the gasifier effluent to provide a sulfur-enriched gasifier effluent (i.e., having an increased concentration of sulfur relative to the gasifier effluent); (c) feeding the sulfur-enriched gasifier effluent to a sour WGS operation, to provide a sour WGS product having a concentration of hydrogen that is increased relative to that of the sulfur-enriched gasifier effluent; and (d) recovering the renewable hydrogen product from the sour WGS product.

Other particular embodiments of the invention are directed to processes for gasification of a carbonaceous feed to produce a renewable hydrogen product, according to which the WGS reaction is carried out more specifically in a sour WGS operation, upstream of scrubbing and/or acid gas removal operations, for overall processing efficiency. Representative processes comprise: in a gasifier, contacting the carbonaceous feed with an oxygen-containing gasifier feed, under gasification conditions, to provide a gasifier effluent comprising synthesis gas; feeding the gasifier effluent to a sour WGS operation to provide a sour WGS product having a concentration of hydrogen that is increased relative to that of the gasifier effluent; and recovering the renewable hydrogen product from the sour WGS product. According to these processes, subsequent to the sour WGS operation (and before recovering the renewable hydrogen product, such as by separating an acid gas product from the sour WGS product), the sour WGS product is subjected to a scrubbing operation (e.g., wet scrubber) to remove water and water-soluble contaminants (e.g., chlorides).

Yet other particular embodiments of the invention are directed to processes for gasification of a carbonaceous feed to produce a renewable hydrogen product, according to which defined operations are utilized for processing the gasifier effluent upstream of the sour WGS operation and/or for processing the sour WGS product downstream of the sour WGS operation, further providing processing efficiency advantages. Representative processes comprise: in a gasifier, contacting the carbonaceous feed with an oxygen-containing gasifier feed, under gasification conditions, to provide a gasifier effluent comprising synthesis gas (which includes both H₂ and CO); subjecting the gasifier effluent to at least a tar removal operation and a dry quenching operation, upstream of a sour WGS operation; increasing a sulfur concentration of the gasifier effluent to provide a sulfur-enriched gasifier effluent (i.e., having an increased concentration of sulfur relative to the gasifier effluent); feeding the sulfur-enriched gasifier effluent to a sour WGS operation, to provide a sour WGS product having a concentration of hydrogen that is increased relative to that of the sulfur-enriched gasifier effluent; subjecting the sour WGS product to a scrubbing operation (e.g., wet scrubber) to remove water and water-soluble contaminants and provide a scrubbed sour WGS product; contacting the scrubbed sour WGS product with a physical or chemical solvent to separate an acid gas product from the scrubbed sour WGS product to provide (e.g., recover) the renewable hydrogen product, wherein the acid gas product includes sulfur compounds; and recycling the acid gas product to combine with the gasifier effluent to carry out the increasing of the sulfur concentration of the gasifier effluent.

Further advantages may be attained in embodiments benefitting from the integration of generated steam. For example, such embodiments may further comprise: subjecting the gasifier effluent to a pre-shift heat recovery operation to provide pre-shift generated steam and feeding the pre-shift generated steam to one of both of the gasifier and the sour WGS operation; and/or subjecting the sour WGS product to a post-shift heat recovery operation to provide post-shift generated steam and feeding the post-shift generated steam to one or both of the gasifier and the sour WGS operation.

These and other embodiments, aspects, and advantages relating to the present invention are apparent from the following Detailed Description.

### BRIEF DESCRIPTION OF THE DRAWING

A more complete understanding of the exemplary embodiments of the present invention and the advantages thereof may be acquired by referring to the following description in conjunction with the accompanying Figure.

The Figure depicts a flowscheme illustrating an embodiment of a process for the gasification of a carbonaceous feed to produce a renewable hydrogen product, in which a sour water-gas shift (WGS) operation is fed by a gasifier effluent, having been enriched in sulfur by being combined with an acid gas product that contains gaseous sulfur compounds. This acid gas product is separated from the sour WGS product and is recycled. In the embodiment depicted, heat recovery is used for steam generation both upstream and downstream of the sour WGS operation (i.e., pre-shift generated steam and post-shift generated steam), with the generated steam being input into the gasifier and/or sour WGS operation for improved process integration.

In order to facilitate explanation and understanding, the Figure provides a simplified overview. Some associated equipment such as vessels, heat exchangers, valves, instrumentation, and utilities, is not shown, as its specific description is not essential to the implementation or understanding of the various aspects of the invention. Such equipment would be readily apparent to those skilled in the art, having knowledge of the present disclosure. Other processes for producing a renewable hydrogen product according to other embodiments within the scope of the invention, having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively.

The term “substantially,” as used herein, refers to an extent of at least 95%. For example, the phrase “substantially all” may be replaced by “at least 95%.” The phrases “all or a portion” or “at least a portion” are meant to encompass, in certain embodiments, “at least 50% of,” “at least 75% of,” “at least 90% of,” and, in preferred embodiments, “all.”

Reference to any starting material, intermediate product, or final product, which are all preferably process streams in the case of continuous processes, should be understood to mean “all or a portion” of such starting material, intermediate product, or final product, in view of the possibility that some portions may not be used, such as due to sampling, purging, diversion for other purposes, mechanical losses, etc. Therefore, for example, the phrase “feeding the sulfur-enriched gasifier effluent to a sour WGS operation” should be understood to mean “feeding all or a portion of the sulfur-enriched gasifier effluent to a sour WGS operation.” Even in the case of “all or portion” being the understood meaning, this phrase nonetheless encompasses certain and preferred embodiments as noted above, in the case of this phrase being expressly stated.

Representative processes described herein for the gasification of a carbonaceous feed may comprise a number of unit operations, with one of such operations stated as being performed or carried out “before,” “prior to,” or “upstream of” another of such operations, or with one of such operations being performed or carried out “after,” “subsequent to,” or “downstream of,” another of such operations. These quoted phrases, which refer to the order in which one operation is performed or carried out relative to another, are in reference to the overall process flow, as would be appreciated by one skilled in the art having knowledge of the present specification. More specifically, the overall process flow can be defined by the bulk gasifier effluent flow and/or the bulk sour WGS product flow, as such flow(s) is/are subjected to operations as defined herein. Insofar as the quoted phrases are used to designate order, in specific embodiments these phrases mean that one operation immediately precedes or follows another operation, whereas more generally these phrases do not preclude the possibility of intervening operations. Therefore, for example, the phrase “subsequent to the sour WGS operation, the sour WGS product is subjected to a scrubbing operation,” means, according to a specific embodiment, that the scrubbing operation immediately follows the sour WGS operation. However, this phrase more generally means that one or more intervening operations can be performed or carried out between the sour WGS operation and the scrubbing operation (e.g., a post-shift heat recovery operation can be performed or carried out downstream of the sour WGS operation and upstream of the scrubbing operation, according to the embodiment illustrated in the Figure).

To the extent that representative processes described herein are defined by including certain unit operations, unless otherwise stated or designated (e.g., by using the phrase “consisting of”), such processes do not preclude the use of other operations, whether or not specifically described herein.

Specific processes described herein are defined by a gasifier operation, a sour WGS operation downstream of the gasifier operation, and an acid gas removal operation downstream of the sour WGS operation. The gasifier operation provides a “gasifier effluent” and the sour WGS operation provides a “sour WGS product.”

The term “gasifier effluent” is a general term that refers to the effluent of the gasifier, whether or not having been subjected to one or more operations downstream of the gasifier and upstream of the sour WGS operation. The term “gasifier effluent” therefore encompasses more specific terms that designate (i) the effluent provided directly by the gasifier, i.e., the “raw gasifier effluent,” (ii) the raw gasifier effluent having been subjected to at least a tar removal operation, i.e., a “tar-depleted gasifier effluent,” having a lower concentration of tars and oils relative to the raw gasifier effluent, (iii) the raw gasifier effluent having been subjected to at least a dry quenching operation, i.e., a “quenched gasifier effluent,” having a lower temperature and higher moisture (H₂O) concentration, relative to the raw gasifier effluent, (iv) the raw gasifier effluent having been subjected to at least a filtration operation, i.e., a “filtered gasifier effluent,” having a lower solid particle content, relative to the raw gasifier effluent, (v) the raw gasifier effluent having been subjected to at least a pre-shift heat recovery operation, i.e., a “cooled gasifier effluent,” having a lower temperature, relative to the raw gasifier effluent, (vi) the raw gasifier effluent having been subjected to a step of increasing its sulfur concentration, i.e., a “sulfur-enriched gasifier effluent,” having a higher sulfur concentration, relative to the raw gasifier effluent, and (vii) the raw gasifier effluent having been subjected to any other operation upstream of the sour WGS operation, whether or not specifically described herein. The term “gasifier effluent” and any of the more specific embodiments (i)-(vii) of this term, refer to products (e.g., flow streams) that are upstream of, and optionally may be fed to, the sour WGS operation.

The term “sour WGS product” is a general term that refers to a product of the sour WGS operation, whether or not having been subjected to one or more operations downstream of this operation, and optionally an acid gas removal operation that may be used to recover the renewable hydrogen product. The term “sour WGS product” therefore encompasses more specific terms that designate (i) the product provided directly by the sour WGS operation, i.e., the “immediate sour WGS product,” (ii) the immediate sour WGS product having been subjected to at least a post-shift heat recovery operation, i.e., a “cooled sour WGS product,” having a lower temperature relative to the immediate sour WGS product, (iii) the immediate sour WGS product having been subjected to at least a scrubbing operation (e.g., wet scrubber), i.e., a “scrubbed sour WGS product,” having a lower moisture (H₂O) concentration and lower content of water-soluble contaminants (e.g., chlorides), relative to the immediate sour WGS product, (iv) the immediate sour WGS product having been subjected to at least compression (e.g., fed to a compressor), i.e., a “pressurized sour WGS product,” having a higher pressure relative to the immediate WGS product, and (v) the immediate sour WGS product, having been subjected to any other operation upstream of the sour WGS operation, whether or not specifically described herein. The term “sour WGS product” and any of the more specific embodiments (i)-(v) of this term, refer to products (e.g., flow streams) that are downstream of the sour WGS operation. In preferred embodiments, these products are also upstream of, and optionally may be fed to, an acid gas removal operation.

Representative processes described herein and defined by a gasifier operation, a sour WGS operation downstream of the gasifier operation, and an acid gas removal operation downstream of the sour WGS operation advantageously utilize an acid gas product, which comprises sulfur compounds (e.g., H₂S) and is separated from the sour WGS product, to increase the sulfur concentration of the gasifier effluent upstream of, or within, the sour WGS operation. Alternatively or in combination, such processes may further benefit from the use of a scrubbing operation (e.g., wet scrubber), and more particularly from a configuration in which this operation is downstream of the sour WGS operation and upstream of the acid gas removal operation. Importantly, the efficient use of the sour WGS operation, according to particular embodiments described herein, can obviate the need for a separate sulfur removal operation, and preferably the production of a renewable hydrogen product is achieved without sulfur removal either upstream of the sour WGS operation, or possibly anywhere else in the process, with the exception of the acid gas removal operation that provides the renewable hydrogen product. For example, processes described herein may avoid, or exclude, the separate removal of sulfur compounds, such as by utilizing a guard bed that may include an iron-or zinc oxide-containing material. That is, a step or operation for such separate removal of sulfur compounds may be absent in certain embodiments.

In addition to a gasifier operation, a sour WGS operation, and an acid gas removal operation, representative processes may optionally include other operations, for example one or more of a tar removal operation, a dry quenching operation, a filtration operation, and a pre-shift heat recovery operation, any of which, or any combination of which is/are preferably performed or carried out downstream of the gasifier and upstream of the sour WGS operation. Alternatively, or in combination, representative processes may optionally include a post-shift heat recovery operation, a scrubbing operation (e.g., wet scrubber), and compression, any of which, or any combination of which is/are preferably performed or carried out downstream of the sour WGS operation and upstream of the acid gas removal operation. Possible features of these operations and their associated process streams and conditions, according to preferred embodiments, are provided in the following description.

### Gasifier

Representative processes comprise, in a gasifier, contacting a carbonaceous feed with an oxygen-containing gasifier feed, under gasification conditions, to provide a gasifier effluent (e.g., a raw gasifier effluent) comprising synthesis gas.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass (e.g., wood), and particular aspects of the invention relate the advantages that are gained from the use of feeds having a sulfur content (concentration) of less than about 500 wt-ppm (e.g., from about 1 to about 500 wt-ppm), less than about 200 wt-ppm (e.g., from about (5 to about 200 wt-ppm), or less than about 100 wt-ppm (e.g., from about 10 to about 100 wt-ppm). The use of such feeds in conventional gasification processes would be incompatible with a sour WGS operation (e.g., without recycle of an acid gas product) having a catalyst system in which the metals are active in, and should therefore be maintained in, their sulfided state.

The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is wood.

In the gasifier (or, more particularly, a gasification reactor of this gasifier), the carbonaceous feed is subjected to partial oxidation in the presence of an oxygen-containing gasifier feed, added in an amount generally limited to supply only 20-70% of the oxygen that would be necessary for complete combustion. The oxygen-containing gasifier feed will generally comprise other oxygenated gaseous components including H₂O and/or CO₂ that may likewise serve as oxidants of the carbonaceous feed. The oxygen-containing gasifier feed can refer to all gases being fed or added to the gasifier, whether or not combined upstream of, or within, the gasifier. For example, the oxygen-containing gasifier feed may comprise a fresh or makeup gasifier feed, in addition to at least a portion of steam generated elsewhere in the process (e.g., pre-shift generated steam and/or post-shift generated steam). Contacting of the carbonaceous feed with the oxygen-containing gasifier feed in the gasifier provides a gasifier effluent, and more particularly a raw gasifier effluent as the product directly exiting the gasifier. One or more reactors (e.g., operating in series or parallel) of the gasifier may operate under gasification conditions present in such reactor(s), with these conditions including a temperature of generally from about 500° C. (932° F.) to about 1000° C. (1832° F.), and typically from about 750° C. (1382° F.) to about 950° C. (1742° F.). Other gasification conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi).

Gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O- and/or CO₂-containing feeds, being fed upwardly through the particle bed. Exemplary types of fluidized beds include bubbling fluidized beds and entrained fluidized beds.

In addition to gasifier effluent tar, the raw gasifier effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in the Figure, the raw gasifier effluent 16 may be obtained directly from gasifier 50, prior to further operations as described herein.

The raw gasifier effluent, or any gasifier effluent having been subjected to one or more operations as described herein, may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent may be suitable for use in downstream reactions, such as (i) the conversion to higher molecular weight hydrocarbons and/or alcohols of varying carbon numbers via Fischer-Tropsch conversion or (ii) the conversion to renewable natural gas (RNG) via catalytic methanation that increases the methane content in a resulting RNG stream. More typically, however, a sour WGS operation is needed to achieve a favorable H₂:CO molar ratio, and/or a favorable H₂ concentration, for these or other downstream applications, including fuel cell electricity generation or refinery hydroprocessing.

Independently of, or in combination with, the representative amounts (concentrations) of H₂ and CO above, the gasifier effluent may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent. That is, these non-condensable gases and any water may be present in the gasifier effluent in a combined amount of at least about 90 mol-%, at least about 95 mol-%, or even at least about 99 mol-%.

### Tar Removal Operation

The raw gasifier effluent, obtained directly from the gasifier, will generally comprise gasifier effluent tar, such that a tar removal operation is typically necessary for further processing. This gasifier effluent tar can include compounds that are referred to in the art as “tars” and “oils” and are more particularly hydrocarbons and oxygenated hydrocarbons having molecular weights greater than that of methane, which may be present in the gasifier effluent at concentrations ranging from several wt-ppm to several wt-%. Certain types of these compounds, having relatively high molecular weight, are further characterized by being problematic due to their tendency to condense at lower temperatures and coat internal surfaces of processing equipment, downstream of the gasifier, causing undesirable fouling, corrosion, and/or plugging. These compounds also interfere with subsequent processing steps for upgrading synthesis gas to higher value products, which perform optimally (e.g., from the standpoint of stability) with pure feed gases.

Particular compounds that are undesirable for these reasons include hydrocarbons and oxygenated hydrocarbons having six carbon atoms or more (C₆⁺hydrocarbons and oxygenated hydrocarbons), with benzene, toluene, xylenes, naphthalene, phenol, and cresols being specific examples. These compounds are typically present in the raw gasifier effluent in a total (combined) amount from 1-100 g/Nm³. The removal (e.g., by conversion) of these organic compounds is therefore generally necessary to avoid serious problems caused by their deposition over time. Other types of tars and oils, such as ethane, ethylene, and acetylene, will not condense from the gasifier effluent but will nonetheless “tie up” hydrogen and carbon, with the effect of reducing the overall yield of H₂ and CO as the desired components of synthesis gas.

Depending on the specific tar removal operation, tars and oils in the raw gasifier effluent can be converted, either catalytically or non-catalytically, by oxidation, cracking, and/or reforming to provide, in the regeneration effluent, additional H₂ and CO. The conversion reaction(s) can utilize available O₂ or oxygen sources (e.g., H₂O and/or CO₂) that are present in, and/or added to, the synthesis gas. In view of the gasifier effluent tar, together with methane, containing a significant portion of the energy of the raw gasifier effluent, the conversion of these compounds can increase the overall yield of synthesis gas substantially. The tar removal operation, which may therefore, according to certain embodiments, be more specifically a tar conversion operation, can effectively reduce the concentration of compounds present as tar in the raw gasifier effluent, having been produced in the gasifier. In general, tar removal, and more particularly tar conversion reactions, may be performed under hotter conditions compared to those used in the gasifier, such that the tar-depleted gasifier effluent, obtained directly from the tar removal operation, may have a temperature of greater than about 1000° C. (e.g., from about 1000° C. (1832° F.) to about 1500° C. (2732° F.), such as from about 1000° C. (1832° F.) to about 1250° C. (2282° F.)).

According to one embodiment, the tar removal operation may be used for the conversion (e.g., reforming) of tar and methane through non-catalytic partial oxidation (Pox). The efficiency of this specific operation can be promoted using hot oxygen burner (HOB) technology, according to which an excess of oxygen is mixed with a small amount of fuel (e.g., natural gas, propane, or recycled synthesis gas). Combustion of this fuel can result in a temperature increase to above 1100° C. (2012° F.), causing the combustion products and excess oxygen to accelerate to sonic velocity through a nozzle, thereby forming a turbulent jet that enhances mixing between the tar/methane containing synthesis gas and the reactive hot oxygen stream. An HOB-based system can effectively improve synthesis gas yields.

In the case of a tar removal operation that utilizes catalytic conversion of tar and methane, this operation may include a reactor containing a bed of catalyst comprising solid or supported Ni, solid or supported Fe, and/or dolomite, for example in the form of a secondary fluidized bed downstream of the gasifier. Other catalysts for tar conversion include olivine, limestone, zeolites, and even metal-containing char produced from the gasification. As in the case of non-catalytic processes that may be performed in a tar removal operation, catalytic tar conversion may likewise include the introduction of supplemental oxygen and/or steam reactants, into a reactor used for this operation.

According to other particular embodiments, the tar removal operation may utilize a suitable liquid or solid adsorbent, to selectively adsorb tars and oils from the raw gasifier effluent. For example, the tar removal operation may by performed with an oil washing system, whereby the gasifier effluent is passed through (contacted with) a liquid medium such as bio-oil liquor, to extract the tars and oils based on their preferential solubility. The liquid adsorbent may be combusted after it has become spent.

Regardless of the particular method by which the tar removal operation is performed, the raw gasifier effluent may comprise tars and oils (e.g., present as compounds described above) in an amount, or combined amount, from about 0.01 wt-% to about 5 wt-%, such as from about 0.1 wt-% to about 3 wt-% or from about 0.5 wt-% to about 2 wt-%. The tar removal operation may be effective to substantially or completely remove this gasifier effluent tar. For example, the tar-depleted gasifier effluent exiting, or obtained directly from, this operation, may comprise tars and oils in an amount, or combined amount, of less than about 0.5 wt-%, less than about 0.1 wt-%, or less than about 0.01 wt-%. Representative levels of removal of tars and oils (e.g., by conversion), measured across the tar removal operation, may be at least about 90%, at least about 95%, or even at least about 99%, resulting in a tar-depleted gasifier effluent that may be substantially or completely free of tar.

### Dry Quenching Operation

Hot gasifier effluent, for example the tar-depleted gasifier effluent exiting the tar removal operation, can be cooled by various techniques that include radiant and/or convective heat exchange. In preferred embodiments, at least one dry quenching operation is used, in which water is added directly to the gasifier effluent and contributes to its overall moisture content, thereby favoring H₂ production via the equilibrium-limited WGS reaction (i.e., to provide an increased H₂:CO molar ratio and increased H₂ concentration). A dry quenching operation utilizes the sensible heat of the gasifier effluent to vaporize the injected water, which is sufficient for obtaining the resulting quenched gasifier effluent at a desired, cooler temperature, such as from about 400° C. (752° F.) to about 550° C. (1022° F.), and preferably from about 450° C. (842° F.) to about 500° C. (932° F.) to allow for further processing. This can include a subsequent filtration operation (passage through a filter) to remove solid particles (e.g., dust). In preferred embodiments, only a partial quench is used, as opposed to a full quench, such that the quenched gasifier effluent exiting, or obtained directly from, the dry quenching operation is above its dewpoint, i.e., not saturated. In general, the dry quenching operation can promote rapid and efficient cooling through direct contact between hot gasifier effluent and water as a quenching medium.

### Filtration Operation

Filtration operation, using any suitable filter, may be used to remove solid particles (particulates) from the gasifier effluent, for example the quenched gasifier effluent as described above. In the case of biomass gasification, these solid particles can include char, tar, soot, and ash, any of which can generally contain alkali metals such as sodium. Corrosive and/or harmful species such as chlorides, arsenic, and/or mercury may also be contained in such solid particles. A high temperature filtration, for example using bundles of metal or ceramic filters, may generally be sufficient to reduce the content of solid particles in the gasifier effluent, such as to provide a filtered gasifier effluent exiting, or obtained directly from, the filtration operation and having less than 1 wt-ppm, and possibly less than 0.1 wt-ppm of solid particles.

In some embodiments, a filtration operation may be performed upstream of (prior to) the tar removal operation to allow the latter to operate more effectively. The removal of solid particles of varying average particles sizes, using filtration or other techniques, may be performed at any of a number of possible stages within the overall process. For example, coarse solids removal by centrifugation may be performed directly downstream of the gasifier, and/or may even be performed in situ in the gasifier (e.g., using internal cyclones, for removal of solid particles, positioned in a headspace above a fluidized particle bed).

The filtration operation may be followed by, or integrated with, a supplemental cleaning operation to further purify the gasifier effluent, such as to further reduce its tar and overall hydrocarbon content, for example by contact with a solid “polishing” material such as a carbon bed. This can provide for more thorough removal of benzene, naphthalene, toluene, phenols, and other condensable species that could otherwise be detrimental to downstream operations, such as by deposition onto equipment.

### Sour WGS Operation

The sour water gas shift (WGS) reaction reacts CO present in the gasifier effluent, for example a sulfur-enriched gasifier effluent resulting from the addition of sulfur to a filtered gasifier effluent as described above, or possibly to a cooled gasifier effluent following a pre-shift heat recovery operation as described herein, with steam to increase H₂ concentration (as well as CO₂ concentration) in the presence of H₂S. The use of steam in excess of the stoichiometric amount may be beneficial, particularly in adiabatic, fixed-bed reactors, for a number of purposes. These include driving the equilibrium toward hydrogen production, adding heat capacity to limit the exothermic temperature rise, and minimizing side reactions, such as methanation. Reactors used in a sour WGS operation may contain a suitable catalyst, such as those comprising one or more of Co, Ni, Mo, and W on a solid support, particular examples of which are Co/Mo and Ni/Mo catalysts. The presence of H₂S in the sour WGS operation (e.g., in the environment of the reactor(s) used in this operation) is generally necessary to maintain these metals in their active, sulfided state (i.e., as their corresponding sulfide compounds). Other catalysts for use in this operation (i.e., contained within one or more sour WGS reactors) include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃—Cr₂O₃ catalysts).

The selection of a catalyst will typically depend, at least in part, on the sulfur content of the gas being fed to, and reacted in, the sour WGS operation (i.e., within the reaction environment of one or more reactors of this operation). Certain catalysts, such as those described above and comprising metals that are desirably maintained in their sulfided (e.g., as opposed to oxidized) state, may be compatible with a reaction environment having at least about 50 vol-ppm (e.g., from about 50 to about 2000 vol-ppm), at least about 100 vol-ppm (e.g., from about 100 to about 1000 vol-ppm), or at least about 150 vol-ppm (e.g., from about 150 to about 500 vol-ppm) of total sulfur (e.g., present as H₂S, optionally in combination with other sulfur-containing compounds). Other catalysts may be compatible with a reaction environment having a lower sulfur content, such as at least about 0.5 vol-ppm (e.g., from about 0.5 to about 100 vol-ppm), at least about 1 vol-ppm (e.g., from about 1 to about 100 vol-ppm), or at least about 5 vol-ppm (e.g., from about 5 to about 100 vol-ppm). As described herein with respect to embodiments utilizing a sulfur-containing recycle gas, this gas may contribute significantly to (e.g., may contribute to at about least 25%, at least about 50%, or at least about 75%) of the sulfur content in the reaction environment of one or more reactors of the sour WGS operation. The sulfur content of the carbonaceous feed may, at least to some extent, determine the sulfur content of the reaction environment of the sour WGS operation and/or of the sulfur-containing recycle gas, and consequently may, at least to some extent, also determine the selection of catalyst. In this regard, it can be appreciated that the term “sour WGS operation,” in some embodiments, can refer to a unit operation utilizing one or more reactors containing a catalyst having metal(s) being active in its/their sulfided state and utilizing a reaction environment having a relatively high sulfur content such as described above. In other embodiments, this term can refer to a unit operation utilizing one or more reactors containing a catalyst having metal(s) not necessarily being more active in its/their sulfided state, and/or utilizing a reaction environment having a relatively low sulfur content such as described above, for example in the case of this catalyst exhibiting a low sulfur tolerance but nonetheless exhibiting sufficient activity for use under conditions within the sour WGS operation.

In a typical sour WGS operation, two or more reactors with interstage cooling are used in view of the thermodynamic characteristics of the sour shift reaction. For example, a high-temperature shift (HTS) reactor may operate with a temperature of the reactor inlet from about 310° C. (590° F.) to about 450° C. (842° F.), with more favorable reaction kinetics but a less favorable equilibrium conversion. The effluent from the HTS may then be cooled to a temperature suitable for the reactor inlet of a low-temperature shift (LTS) reactor, such as from about 200° C. (392° F.) to about 250° C. (482° F.), for providing less favorable reaction kinetics but a more favorable equilibrium conversion, such that the combined effect of the HTS and LTS reactors results in a high conversion to H₂ with a favorable residence time. In some cases, it may be desirable to use three or more reactors, or catalyst beds, to perform the sour WGS reaction, again with cooling between consecutive reactors or catalyst beds.

In this manner, the sour WGS operation may be used to provide an immediate sour WGS product exiting, or obtained directly from, this operation and having an increased H₂:CO molar ratio and increased H₂ concentration, relative to the sulfur-enriched gasifier effluent, or the gasifier effluent obtained from upstream operations (e.g., filtered gasifier effluent or cooled gasifier effluent). For example, the immediate sour WGS product may have an H₂:CO molar ratio from about 0.5 to about 3.5, from about 1.0 to about 3.0, or from about 1.5 to about 2.5 and/or a hydrogen concentration of at least about 35 mol-% (e.g., from about 35 mol-% to about 80 mol-%), at least about 40 mol-% (e.g., from about 40 mol-% to about 70 mol-%), or at least about 45 mol-% (e.g., from about 45 mol-% to about 65 mol-%). These characteristics of the immediate sour WGS product may be controlled by bypassing the sour WGS operation to a greater or lesser extent (e.g., diverting a smaller or larger portion of the feed to this operation, such as the sulfur-enriched gasifier effluent, around this operation to provide a portion of the immediate sour WGS product). The sour WGS operation is further beneficial in terms of converting carbonyl sulfide (COS) to H₂S which can be separated and recycled to the sour WGS operation, to provide advantages as described herein.

### Scrubbing Operation

A scrubbing operation may be used to remove water and water-soluble contaminants from the sour WGS product, for example the immediate sour WGS product exiting the sour WGS operation as described above, or possibly a cooled sour WGS product following a post-shift heat recovery operation as described herein. Scrubbing operation, such as wet scrubbing, may be effective for removing chlorides (e.g., in the form of HCl) and ammonia, as well as fine solid particles (e.g., char and ash). For example, in the case of using a wet scrubber, the sour WGS product may be fed to a trayed column to perform co-current or counter-current contacting with water. Further cooling in this column, such as to a temperature below 100° C. (212° F.) can aid in droplet condensation for improving the contaminant removal effectiveness. The scrubbing operation can be used to provide a scrubbed sour WGS product exiting, or obtained directly from, this operation and having a combined amount of chloride, ammonia, and solid particles of less than 1 wt-ppm, and possibly less than 0.1 wt-ppm. The scrubbing operation also generally serves to remove water from the sour WGS product, such that the moisture content of the scrubbed sour WGS product is reduced, relative to the feed to the scrubbing operation (e.g., immediate sour WGS product or cooled sour WGS product).

### Acid Gas Removal Operation

An acid gas removal operation may be used to separate an acid gas product from the sour WGS product, for example the scrubbed sour WGS product described above or a pressurized sour WGS product following compression as described herein. The acid gas product may be an H₂S-enriched product (e.g., having a higher H₂S concentration compared to that of the sour WGS product), which may be advantageously recycled to maintain activity of catalyst used in the sour WGS operation, as described herein. The acid gas product may also be enriched in other sulfur compounds, such as COS and/or SO₂, as well as being enriched in overall sulfur content (concentration), relative to the sour WGS product. In some embodiments, the acid gas removal operation may further provide a CO₂-enriched product (e.g., as a second acid gas product having a higher CO₂ concentration compared to that of the sour WGS product, which may be the scrubbed sour WGS product or pressurized sour WGS product). If a CO₂-enriched product is recovered, this may or may not be recycled to the process.

The acid gas removal operation may therefore be used to reduce the concentration of H₂S and/or CO₂ in the sour WGS product (e.g., scrubbed sour WGS product or pressurized sour WGS product) and provide the renewable hydrogen product exiting, or obtained directly from, this operation. In the case of an upstream scrubbing operation being utilized, this may provide the requisite degree of dehydration of the scrubbed sour WGS product or pressurized sour WGS product, for use as a feed to the acid gas removal operation. The combined effects of the sour WGS operation (to produce H₂) and the acid gas removal operation (to purify H₂) can provide a renewable hydrogen product having a hydrogen concentration of at least about 50 mol-% (e.g., from about 50 mol-% to about 98 mol-%), at least about 55 mol-% (e.g., from about 55 mol-% to about 95 mol-%), or at least about 60 mol-% (e.g., from about 60 mol-% to about 90 mol-%). The renewable hydrogen product may have a CO₂ concentration generally from about 1 mol-% to about 25 mol-%, and typically from about 2 mol-% to about 20 mol-%, and may have a total sulfur content (concentration) of less than about 0.1 mol-ppm.

The acid gas removal operation may utilize one or more stages of contacting with a physical solvent such as Selexol® (dimethyl ethers of polyethylene glycol), Rectisol® (cold methanol), or a combination thereof. In the case of a physical solvent, acid gases are selectively solubilized in this solvent under elevated pressure, and the solvent may be regenerated, together with the release of a separated acid gas product, upon reducing pressure. Alternatively, the acid gas removal operation may utilize one or more stages of contacting with a chemical solvent, examples of which are amine solvents such as monoethanolamine, diethanolamine, methyldiethanolamine (MDEA), diisopropylamine, or diglycolamine. In the case of a chemical solvent, acid gases are selectively absorbed by chemical interactions, and the solvent may be regenerated, together with the release of a separated acid gas product, upon heating. Other solvents, such as methanol, potassium carbonate, a solution of sodium salts of amino acids, etc. can also be used to remove at least a portion of an acid gas initially present in the sour WGS product (e.g., scrubbed sour WGS product or pressurized sour WGS product). The physical or chemical solvent can promote the selective removal of H₂S/COS, in addition to the removal of CO₂ in this product. In the case of a physical solvent such as Selexol®, this may generally be suitable for temperatures up to 175° C. (347° F.). Regeneration of the rich physical or chemical solvent, such as after having reached substantially its capacity for the removal of acid gases, can release the acid gas product, as an H₂S-enriched product. For example, regeneration can be carried out by desorption of the rich solvent by flashing (depressurization), thermal treatment, and/or the use of stripping gas.

### Further Exemplary Embodiments of Gasification Processes

The Figure depicts a flowscheme illustrating an embodiment of a process including operations as described above, and further integrated with pre-shift heat recovery and post-shift heat recovery operations, for the generation of steam that can be used in the process. According to this embodiment, in gasifier 50, carbonaceous feed 10 is combined with oxygen-containing gasifier feed 14 under gasification conditions to provide a gasifier effluent, in this case raw gasifier effluent 16 comprising synthesis gas. Oxygen-containing gasifier feed 14 comprises both makeup gasifier feed 12 and at least a portion of pre-shift generated steam 26. Oxygen-containing gasifier feed 14 may comprise H₂O and O₂, as well as optionally CO₂, in a combined concentration of at least about 90 mol-%, at least about 95 mol-%, or at least about 99 mol-%.

In general, representative processes may comprise increasing the sulfur content (concentration) of the gasifier effluent to provide a sulfur-enriched gasifier effluent. According to the embodiment illustrated in the Figure, the sulfur content of the gasifier effluent, such as cooled gasifier effluent 28, is increased prior to sour WGS operation 75, by combining acid gas product 46 comprising sulfur compounds (e.g., H₂S) with the gasifier effluent. However, the sulfur content may alternatively be increased in this operation, for example by separately feeding the gasifier effluent and the acid gas product containing sulfur compounds to sour WGS operation 75. As illustrated, the sulfur content may be increased, more particularly by recycling acid gas product 46 to provide at least a portion of sulfur-containing recycle gas 42 that combines with the gasifier effluent, to provide sulfur-enriched gasifier effluent 30. Representative processes may further comprise feeding sulfur-enriched gasifier effluent 30 to sour WGS operation 75 and provide a sour WGS product, which may be more particularly immediate sour WGS product 32, having a concentration of hydrogen that is increased relative to that of sulfur-enriched gasifier effluent 30.

As described above, a sufficient sulfur concentration in the environment of sour WGS operation 75 may be necessary to maintain catalyst used for this operation in its active, sulfided state. For this purpose, the sulfur content (concentration) in sulfur-containing recycle gas 42 may be maintained, for example, in the range from about 100 to about 1000 vol-ppm, such as from about 150 to about 500 vol-ppm. This sulfur concentration may likewise be representative of that in any one or more of sulfur-enriched gasifier effluent 30, sour WGS feed 35, and sour WGS operation 75. The sulfur concentration in these and other streams/operations in the recycle loop through which H₂S and other sulfur compounds are predominantly retained, may be regulated (raised or lowered), for example, by purging a smaller or greater portion, respectively, of this recycle gas through recycle loop purge 47, which also mitigates excessive accumulation of unwanted impurities in the recycle gas such as certain non-condensable gases (e.g., nitrogen). This sulfur concentration may also be regulated by the addition of sulfur to this recycle loop (e.g., the gas streams that can include one or more of acid gas product 46, sulfur-containing recycle gas 42, sulfur-enriched gasifier effluent 30, sour WGS feed 35, sour WGS product 32, cooled sour WGS product 36, scrubbed sour WGS product 38, and pressurized sour WGS product 40). In this regard, makeup sulfur-containing feed 44 may be combined with any stream of this recycle loop, for example with acid gas product 46 to provide sulfur-containing recycle gas 42 as illustrated. Makeup sulfur-containing feed 44 may have a sulfur content (concentration) higher than that present at any point in the recycle loop and may comprise H₂S otherwise a sulfur-containing precursor that can readily decompose in the environment of the recycle loop to form H₂S. Representative sulfur-containing precursors are dimethyl disulfide (DMDS) and di-tertiary-butyl polysulfide (TBPS), which are more easily handled relative to gaseous H₂S. Representative processes may further comprise recovering renewable hydrogen product 45 from a sour WGS product, for example pressurized sour WGS product 40, with the renewable hydrogen product (e.g., an H₂-enriched product) resulting from the separation, using acid gas removal operation 95, of acid gas product 46 (e.g., an H₂S-enriched product) and optionally a second acid gas product, such as CO₂-enriched product 48, from the sour WGS product.

Prior to the step of increasing its sulfur concentration, the gasifier effluent, such as raw gasifier effluent 16 obtained directly from gasifier 50, may be subjected to one or more of: tar removal (e.g., tar reforming) operation 55, such as to provide tar-depleted gasifier effluent 18; dry quenching operation 60 to which quench water 20 is fed for cooling, such as to provide quenched gasifier effluent 22; filtration operation 65, such as to provide filtered gasifier effluent 24; and pre-shift heat recovery operation 70, such as to provide cooled gasifier effluent 28. In a preferred embodiment illustrated in the Figure, all of these operations are used, in the order listed above, prior to increasing the sulfur concentration of the gasifier effluent, such as by combining cooled gasifier effluent 28 with acid gas product 46, and also prior to feeding sulfur-enriched gasifier effluent 30 to sour WGS operation 75. Whereas steps of increasing the sulfur concentration of the gasifier effluent and feeding the sulfur-enriched gasifier effluent may be performed sequentially as illustrated, these steps may otherwise be performed in the sour WGS operation 75 (e.g., simultaneously), such as by feeding both cooled gasifier effluent 28 and acid gas product 46 directly to this operation, or to a sour WGS reactor used in this operation.

As further illustrated, recovering renewable hydrogen product 45 may comprise separating acid gas product 46 comprising sulfur compounds (e.g., H₂S) from a sour WGS product, in this case pressurized sour WGS product 40. This separation may be performed or carried out in acid gas removal operation 95. As described above, this operation may utilize a physical or chemical solvent, such that separating acid gas product 46 from the sour WGS product may comprise contacting this product with a physical solvent (e.g., Selexol®) or a chemical solvent (e.g., MDEA or other amine as described above). In this case, acid gas product 46 comprising sulfur compounds (e.g., H₂S) may be released, upon regeneration of the physical solvent. The released acid gas product 46 may then provide at least a portion of sulfur-containing recycle gas 42. In this manner, acid gas product 46, which combines with the gasifier effluent to increase its sulfur content (concentration), may be separated from the sour WGS product using a physical solvent. The step of increasing the sulfur concentration of the gasifier effluent may therefore, more particularly, comprise recycling acid gas product 46 to combine with the gasifier effluent, such as cooled gasifier effluent 28. As noted above, in addition to providing acid gas product 46, for example as an H₂S-enriched product, acid gas removal operation 95 may also provide CO₂-enriched product 48 as a second acid gas product.

Prior to the step of separating acid gas product 46 from the sour WGS product, the immediate sour WGS product 32 obtained directly from sour WGS operation 75, may be subjected to one or more of: post-shift heat recovery operation 80, such as to provide cooled sour WGS product 36; scrubbing operation (e.g., wet scrubber) 85, such as to provide scrubbed sour WGS product 38; and compression, for example using compressor 90, such as to provide pressurized sour WGS product 40. In a preferred embodiment illustrated in the Figure, all of these operations are used, in the order listed above, prior to recovery of the renewable hydrogen product.

According to specific embodiments, heat recovery and steam generation may be integrated into the process. For example, the gasifier effluent, such as filtered gasifier effluent 24, may be subjected to pre-shift heat recovery 70, prior to or upstream of sour WGS operation 75, thereby providing cooled gasifier effluent 28. Indirect, or heat exchanging, contact between the gasifier effluent and pre-shift boiler feed water 25a can yield pre-shift generated steam 26. Likewise, the sour WGS product, such as immediate sour WGS product 32, may be subjected to post-shift heat recovery 80, subsequent to or downstream of sour WGS operation 75, thereby providing cooled sour WGS product 36. Indirect, or heat exchanging, contact between the sour WGS product and post-shift boiler feed water 25b can yield post-shift generated steam 34. To achieve various objectives described herein, representative processes may comprise feeding pre-shift generated steam 26 and/or post-shift generated steam 34 to one or both of gasifier 50 and sour WGS operation 75. Therefore, the combination of pre-and/or post-shift generated steam 26, 34 and makeup gasifier feed 12 may be used to provide oxygen-containing gasifier feed 14. Likewise, the combination of pre-and/or post-shift generated steam 26, 34 and sulfur-enriched gasifier effluent may be used to provide sour WGS feed 35.

The recovery of renewable hydrogen product 45 may therefore involve the combined use of sour WGS operation 75 and acid gas removal operation 95 for H₂ production and H₂ purification, respectively. Feeding of the gasifier effluent, such as sulfur-enriched gasifier effluent 30, to sour WGS operation provides a sour WGS product, such as immediate sour WGS product 32 having a concentration of hydrogen that is increased relative to that of the gasifier effluent. Both the H₂ concentration and the H₂:CO molar ratio of the sour WGS product may be controlled by adjusting a relative amount of bypass portion 28a of the gasifier effluent, such as cooled gasifier effluent 28, that may be diverted around sour WGS operation 75. As described herein, advantages may be gained through the use of sour WGS operation, as opposed to utilizing water-gas shift that is not tolerant of sulfur and other contaminants, with respect to the ordering of operations, for example according to the illustrated embodiment. Subsequent to sour WGS operation 75, and before recovering renewable hydrogen product 45 using acid gas removal operation 95, the sour WGS product, such as pressurized sour WGS product 40, may be subjected to scrubbing operation (e.g., wet scrubbing) 85 to remove water and water-soluble contaminants (e.g., chlorides). Accordingly, subsequent to or downstream of sour WGS operation 75, the sour WGS product may be subjected to, in addition to scrubbing operation (e.g., wet scrubber) 85, acid gas removal operation 95 that is used for recovering renewable H₂ product 45.

The embodiment illustrated in the Figure is directed to an exemplary process for gasification of carbonaceous feed 10 to produce renewable hydrogen product 45. The process comprises: in gasifier 50, contacting carbonaceous feed 10 with oxygen-containing gasifier feed 14, under gasification conditions, to provide a gasifier effluent (e.g., raw gasifier effluent 16) comprising synthesis gas; subjecting the gasifier effluent (e.g., raw gasifier effluent 16) to at least tar removal operation 55 and dry quenching operation 60, upstream of sour water-gas shift (WGS) operation 75; increasing the sulfur content (concentration) of the gasifier effluent (e.g., cooled gasifier effluent 28) to provide sulfur-enriched gasifier effluent 30 having an increased concentration of sulfur relative to that of the gasifier effluent; feeding sulfur-enriched gasifier effluent 30 to sour water-gas shift (WGS) operation 75, to provide a sour WGS product (e.g., immediate sour WGS product 32) having a concentration of hydrogen that is increased relative to that of sulfur-enriched gasifier effluent 30; subjecting the sour WGS product (e.g., cooled sour WGS product 36) to scrubbing operation (e.g., wet scrubber 85) to remove water and water-soluble contaminants and provide scrubbed sour WGS product 38 having a concentration of water and/or water-soluble contaminants (e.g., chlorides) that is reduced relative to that of cooled sour WGS product 36; contacting scrubbed sour WGS product 38 with a physical solvent to separate acid gas product 46 from scrubbed sour WGS product 38 (optionally following pressurization using compressor 90 to provide pressurized sour WGS product 40) to provide renewable hydrogen product 45 having an H₂:CO molar ratio and/or an H₂ concentration that is increased relative to scrubbed sour WGS product 38 (and optionally pressurized sour WGS product 40). Acid gas product 46 comprises sulfur compounds (e.g., H₂S), and recycling of this product to combine with the gasifier effluent (e.g., cooled gasifier effluent 28) advantageously increases its sulfur concentration for use in sour WGS operation, as described herein.

Overall, aspects of the invention relate to gasification processes for renewable hydrogen product, which utilize a sour WGS operation to carry out this reaction at a stage within the overall process that results in improved processing efficiency and consequently economic advantages (e.g., reduced utility requirements). Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments illustrated and described herein are for illustrative purposes only, and not limiting of the invention as set forth in the appended claims.

1. A process for gasification of a carbonaceous feed to produce a renewable hydrogen product, the process comprising:
(a) in a gasifier, contacting the carbonaceous feed with an oxygen-containing gasifier feed, under gasification conditions, to provide a gasifier effluent comprising synthesis gas;
(b) increasing a sulfur concentration of the gasifier effluent to provide a sulfur-enriched gasifier effluent;
(c) feeding the sulfur-enriched gasifier effluent to a sour water-gas shift (WGS) operation, to provide a sour WGS product having a concentration of hydrogen that is increased relative to that of the sulfur-enriched gasifier effluent; and
(d) recovering the renewable hydrogen product from the sour WGS product.

2. The process of claim 1, wherein, prior to step (b), the gasifier effluent is subjected to one or more of a tar removal operation, a dry quenching operation, a filtration operation, and a pre-shift heat recovery operation.

3. The process of claim 1, wherein steps (b) and (c) are performed in the sour WGS operation.

4. The process of claim 1, wherein step (d) comprises separating an acid gas product from the sour WGS product.

5. The process of claim 4, wherein, prior to said separating the acid gas product from the sour WGS product, the sour WGS product is subjected to one or more of a post-shift heat recovery operation, a scrubbing operation, and compression.

6. The process of claim 4, wherein the acid gas product includes sulfur compounds, and further wherein step (b) comprises recycling the acid gas product to combine with the gasifier effluent.

7. The process of claim 4, wherein said separating the acid gas product from the sour WGS product comprises contacting the sour WGS product with a physical or chemical solvent.

8. The process of claim 7, wherein the acid gas product includes sulfur compounds, wherein the acid gas product is released, upon regeneration of the physical or chemical solvent, and wherein step (b) comprises recycling the acid gas product to combine with the gasifier effluent.

9. The process of claim 1, wherein, prior to step (b), the gasifier effluent is subjected to a pre-shift heat recovery operation to provide pre-shift generated steam.

10. The process of claim 9, further comprising feeding the pre-shift generated steam to one or both of the gasifier and the sour WGS operation.

11. The process of claim 1, wherein, subsequent to step (c), the sour WGS product is subjected to a post-shift heat recovery operation to provide post-shift generated steam.

12. The process of claim 11, further comprising feeding the post-shift generated steam to one or both of the gasifier and the sour WGS operation.

13. A process for gasification of a carbonaceous feed to produce a renewable hydrogen product, the process comprising:
in a gasifier, contacting the carbonaceous feed with an oxygen-containing gasifier feed, under gasification conditions, to provide a gasifier effluent comprising synthesis gas;
feeding the gasifier effluent to a sour water-gas shift (WGS) operation to provide a sour WGS product having a concentration of hydrogen that is increased relative to that of the gasifier effluent; and
recovering the renewable hydrogen product from the sour WGS product,
wherein, subsequent to the sour WGS operation, the sour WGS product is subjected to a scrubbing operation to remove water and water-soluble contaminants.

14. The process of claim 13, wherein a sulfur concentration of the gasifier effluent is increased, prior to or in the sour WGS operation.

15. The process of claim 14, wherein the sulfur concentration of the gasifier effluent is increased, by combining an acid gas product that includes sulfur compounds, with the gasifier effluent.

16. The process of claim 15, wherein the acid gas product is separated from the sour WGS product, following contacting the sour WGS product using a physical or chemical solvent.

17. The process of claim 13, wherein the sulfur content of the carbonaceous feed is less than about 500 wt-ppm.

18. The process of claim 13, wherein, subsequent to the sour WGS operation, the sour WGS product is subjected to, in addition to the wet scrubbing operation, an acid gas removal operation, for said recovering of the renewable hydrogen product.

19. A process for gasification of a carbonaceous feed to produce a renewable hydrogen product, the process comprising:
in a gasifier, contacting the carbonaceous feed with an oxygen-containing gasifier feed, under gasification conditions, to provide a gasifier effluent comprising synthesis gas;
subjecting the gasifier effluent to at least a tar removal operation and a dry quenching operation, upstream of a sour water-gas shift (WGS) operation;
increasing a sulfur concentration of the gasifier effluent to provide a sulfur-enriched gasifier effluent;
feeding the sulfur-enriched gasifier effluent to a sour water-gas shift (WGS) operation, to provide a sour WGS product having a concentration of hydrogen that is increased relative to that of the sulfur-enriched gasifier effluent;
subjecting the sour WGS product to a scrubbing operation to remove water and water-soluble contaminants and provide a scrubbed sour WGS product;
contacting the scrubbed sour WGS product with a physical or chemical solvent to separate an acid gas product from the scrubbed sour WGS product to provide the renewable hydrogen product, wherein the acid gas product includes sulfur compounds; and
recycling the acid gas product to combine with the gasifier effluent for said increasing the sulfur concentration of the gasifier effluent.

20. The process of claim 19, further comprising:
subjecting the gasifier effluent to a pre-shift heat recovery operation to provide pre-shift generated steam and feeding the pre-shift generated steam to one of both of the gasifier and the sour WGS operation; and/or
subjecting the sour WGS product to a post-shift heat recovery operation to provide post-shift generated steam and feeding the post-shift generated steam to one or both of the gasifier and the sour WGS operation.
